(19) United States
(12) Patent Application Publication
(10) Pub. No.: US 2011/0260819 A1
(43) Pub. Date: Oct. 27, 2011

(54) CONTINUOUSLY TUNABLE INDUCTOR WITH VARIABLE RESISTORS

(75) Inventors: Tzu-Jin Yeh, Hsinchu City (TW); Kal-Wen Tan, Taipei City (TW); Ming Hsien Tsai, Sindian City (TW); Chewn-Pu Jou, Chutung (TW); Fu-Lung Hsueh, Cranbury, NJ (US)

(73) Assignee: Taiwan Semiconductor Manufacturing Co., Ltd., Hsin-Chu (TW)

(21) Appl. No.: 12/766,970

(22) Filed: Apr. 26, 2010

(51) Int. Cl. H01F 21/00

(52) U.S. Cl. 336/155

(57) ABSTRACT

An integrated tunable inductor includes a primary inductor having a plurality of inductor turns, at least one closed loop eddy current coil proximate the primary inductor, and at least one variable resistor integrated in series with the eddy current coil.

### FIELD OF THE INVENTION

The present invention relates to the field of integrated inductors, and particularly towards integrated tunable inductors.

### BACKGROUND OF THE INVENTION

An inductor is an electrical device that introduces inductance into a circuit or functions by inductance within a circuit. In some applications, it is useful for inductors to be tunable. For example, circuits designed for RF applications may benefit by using tunable inductors. In particular, tuned circuits that include LC tanks used for loads, filters, impedance matching, or the like may use tunable inductors for tuning center frequencies.

The inductance value, L, of an inductor is dependent upon (among other factors) the number of windings in the coil between two electrical contact points, and one may adjust the number of windings between end points. Such a variable inductor, however, is not available in integrated circuit technology, where mechanically adjustable armatures are not practical. Some known devices use the eddy current to vary the inductance of an inductor. Eddy current is formed when a conductor is exposed to a changing magnetic field due to relative motion of the field source and conductor, or due to variations of the field with time.

An example of a device that uses eddy current to vary the inductance of an inductor is shown in the paper, M. Rais-Zadeh, P. A. Kohl, and F. Ayazi, A Packaged Micromachined Switched Tunable Inductor, Proc. 20^{th}, IEEE Micro Electro Mechanical Systems Conf. (MEMS 2007), Kobe, Japan, January 2007, pp. 799-802 (“Rais-Zadeh”). Rais-Zadeh describes the implementation of tunable inductors using micromachined electrostatically-actuated switches. The tunable inductor of Rais-Zadeh is limited in that it can only be tuned in discrete increments and not across a continuous range of values. A further disadvantage of Rais-Zadeh's tunable inductor is that the micromachined switches are not easily integrated into system-on-a-chip (SOC) designs.

Another example of a device that makes use of eddy current to vary the inductance of an inductor is shown in U.S. Pat. No. 7,202,768, issued to Harvey et al. (“the '768 patent”). The tunable inductor of the '768 patent has an inductor in proximity to one or more sets of eddy current coils. Each eddy current coil is coupled to a corresponding switch that controls whether the eddy current coil is grounded or floating. By selectively coupling and decoupling one or more eddy current coils to ground, the inductance of the inductor can be selectively tuned. As with Rais-Zadeh, the tunable inductor of the '768 patent can only be tuned in discrete increments.

Another example of a device that makes use of eddy current to vary the inductance of an inductor is shown in U.S. Pat. No. 7,598,838, issued to Hargrove et al. (“the '838 patent”). A variable inductor of the '838 patent includes a second closed-loop inductor placed immediately above or below a primary inductor. A current applied to the primary inductor induces an eddy current in the second inductor by inductive coupling. The second current in the second inductor then alters the impedance of the primary inductor by mutual inductance. To produce a variable inductor, each of the closed loop inductors may have its closed loop, i.e. closed current path, selectively broken. There are several disadvantages of the '838 patent. As with the art discussed above, the application is limited to inductance tuning in discrete increments. Also, the presence of switches in a series connection with the spiral inductor can significantly degrade the performance of the inductor due to the high series resistance of the switches.

### SUMMARY OF THE INVENTION

An integrated tunable inductor includes a primary inductor having a plurality of inductor turns, at least one closed loop eddy current coil proximate the primary inductor, and at least one variable resistor integrated in series with the eddy current coil.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a top conceptual view of a continuously tunable inductor according to an embodiment of the present invention;

FIG. 1A is a three-dimensional view of the tunable inductor of FIG. 1;

FIG. 2 is a top view of a primary inductor of the tunable inductor of FIGS. 1 and 1A;

FIG. 3 is a top view of a secondary inductor of the tunable inductor of FIGS. 1 and 1A;

FIG. 3A illustrates an alternative embodiment of a secondary inductor;

FIG. 4 is a schematic diagram illustrating an embodiment of a variable resistor;

FIG. 5 is a graphical depiction showing the inductance of the primary inductor with changes in resistance in the secondary inductor;

FIG. 6 is a schematic diagram illustrating a low noise amplifier having a tunable inductor; and

FIG. 7 illustrates an embodiment of a tunable inductor where the primary and secondary inductors formed in the same plane.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling (whether physical or electrical) and the like, such as “connected” and “interconnected,” refer to a relationship wherein structures are secured or attached to, or communicate with, one another either directly or indirectly through intervening structures, as well as both movable or rigid attachments or relationships, unless expressly described otherwise.

An improved tunable inductor is described below in connection with the drawings. In embodiments, the tunable inductor is configured to allow for continuous tuning of the inductance value of the tunable inductor across a range of values, as opposed to only in discrete increments. In other embodiments, the inductor can be tuned in discrete increments but without the need for high resistance switches in series with the primary inductor, which can cause performance problems as discussed above.

The tunable inductor employs the eddy current effect to tune the inductance of a primary inductor. The tunable inductor includes a, primary inductor, such as a helical or spiral inductor, formed on a semiconductor substrate. The primary inductor can have any number of shapes, such as circular, rectangular, hexagonal, octagonal, etc. A closed loop secondary inductor is magnetically coupled to the primary inductor. The secondary inductor includes one or more eddy current coils and is disposed proximate the primary inductor. One or more variable resistors is placed in series with the secondary inductor to control eddy current in the closed loop secondary inductor. A controller may be provided to adjust the resistance of the variable resistor. The variable resistor may be a voltage variable resistor (MOS transistor), a switch resistor array, or the like.

The tunable inductor, which has an inductance and parasitic capacitance, can provide an optimal inductance-capacitance (LC) tank for high frequency applications. The tunable inductor is relatively simple to implement in a complementary metal-oxide semiconductor (CMOS) processes, such as those used for wireless circuit applications. The tunable inductor described herein can be used in any number of applications, such as wideband CS LNA circuits with a low noise amplifier, phase tuning circuits, high performance LC tanks having high frequency voltage controlled oscillators (VCOs), impedance matching networks, or various filter circuits.

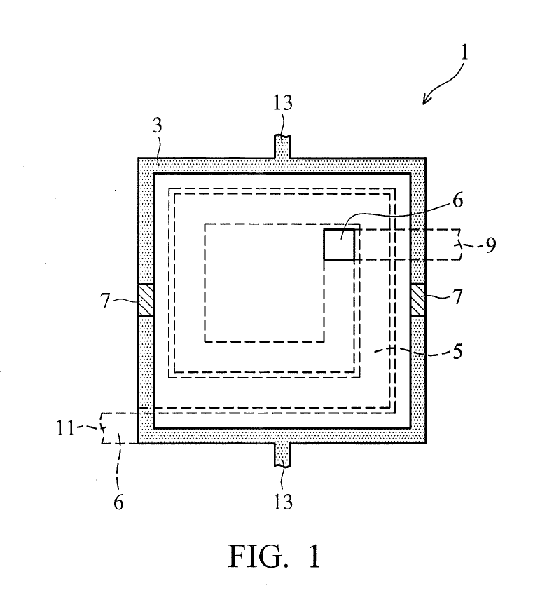

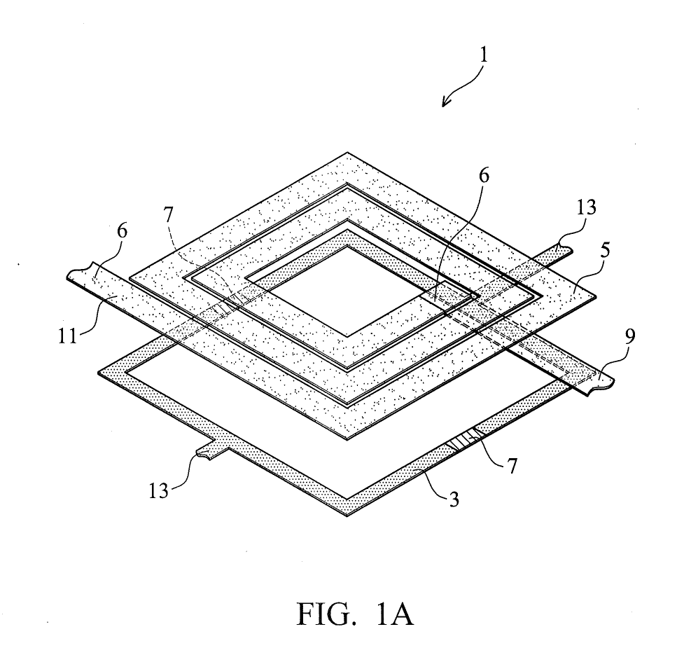

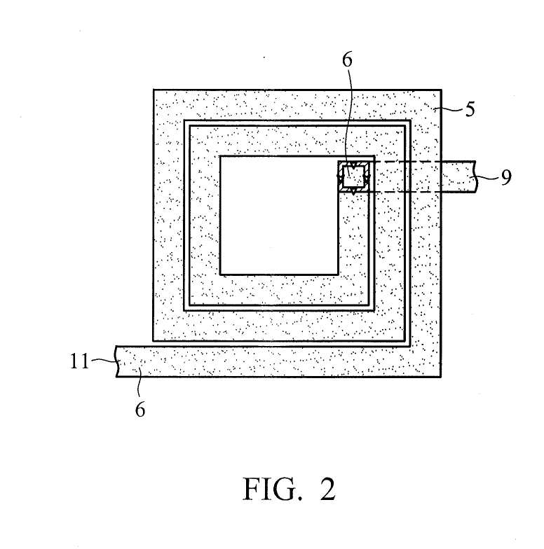

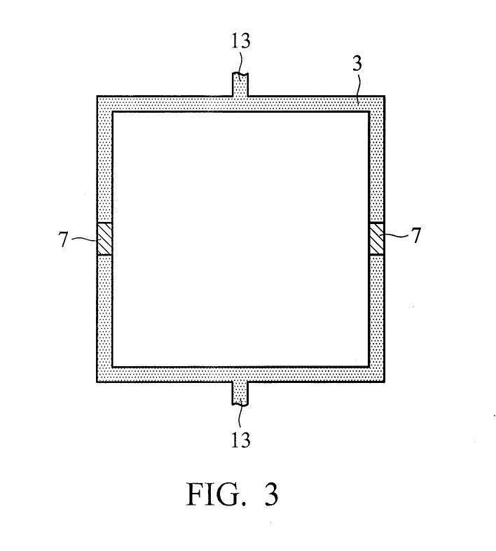

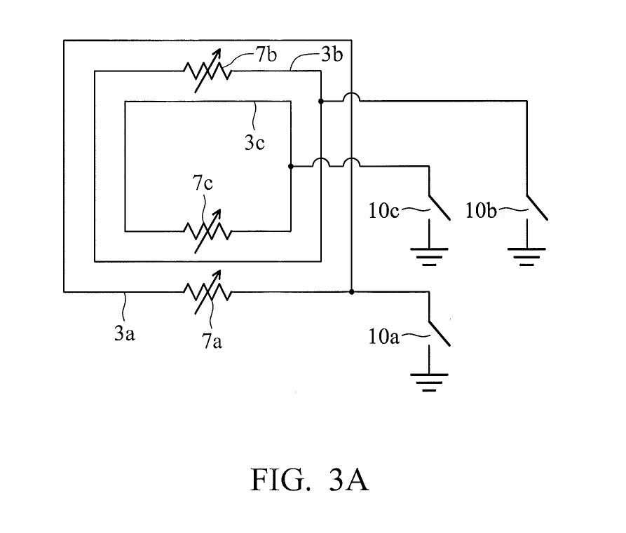

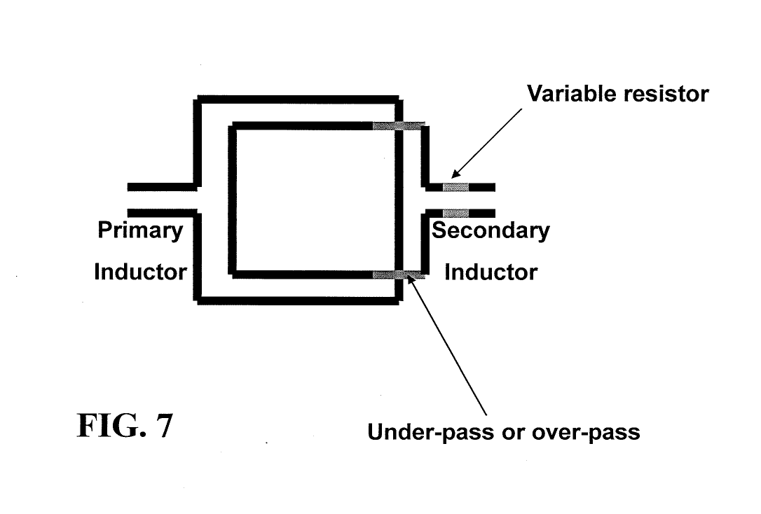

FIG. 1 is a top view of a tunable inductor 1 in accordance with an embodiment of the present invention. FIG. 1A is a stylized perspective view of the tunable inductor 1. Tunable inductor 1 includes a primary inductor 5 and a secondary inductor 3, which includes one or more closed loop eddy current coils. FIG. 2 is a top view of the primary inductor 5, and FIG. 3 is a top view of the secondary inductor 3. Primary inductor 5 (shown in phantom in FIG. 1) is located in close proximity to either the top or bottom surface of secondary inductor 3, such that the inductors 3 and 5 are in magnetic communication with primary inductor 5. Primary inductor 5 is shown to be above secondary inductor 3 in the figures, but this is not intended to be structurally limiting. Secondary inductor 3 may be above or below primary inductor 5, or even in the same plane (see FIG. 7) as the primary inductor as long as they are in magnetic/inductive communication. When formed in an integrated circuit, primary and secondary inductors 5, 3 can be placed on the same or separate metallization layers. The primary inductor 5 may be a spiral or helical coil inductor having one or more turns. A helical inductor may be classified as a substantially 3-dimensional structure, whereas a spiral inductor is a substantially 2-dimensional structure. Current through the inductor induces a first magnetic field. The primary inductor 5 has a standard inductance that may be tuned as described below. Secondary inductor 3 includes a closed loop eddy current coil, e.g., a conductive metal ring. The primary and secondary inductors 5, 3 may be formed from similar electrically conductive materials, such as copper or aluminum. In addition, they may be formed as conductive traces or windings. Secondary inductor 3 has at least one variable resistor 7 (shown in stylized format for ease of illustration) integrated in series with the closed loop eddy current coil. Secondary inductor 3 can be grounded, or left floating, through one or more connections 13. The primary inductor 5 has first and second electrical connections 9, 11 coupled to the respective ends 6 of the coil.

As shown in the figures, secondary inductor 3 is a closed-loop having one or more electrical connections 13. The closed-loop configuration of secondary inductor 3 may be broken on-chip in several ways to include one or more variable resistors 7. Each variable resistor 7 is integrated in series with the closed-loop of the secondary inductor 3.

In an alternative embodiment of secondary inductor 3, the secondary inductor 3 may include two or more closed-loop coils each having a variable resistor 7 integrated in series with a respective closed loop. This configuration allows various tuning ranges as described in, for example, U.S. Pat. No. 7,202,768, the entirety of which is hereby incorporated by reference herein. FIG. 3A is a conceptual diagram illustrating a top view of a set of secondary inductors 3 each having an eddy current coil in series with a variable resistor 7. Specifically, FIG. 3A illustrates first, second and third secondary inductors 3a, 3b, 3c with first, second and third variable resistors 7a, 7b, 7c. Switches 10a, 10b, 10c are connected to the eddy current coils and may be selectively opened and closed to couple one or more of eddy current coils to ground. The illustrated eddy current coils are shown as concentric coils and may be on a single plane. These concentric eddy current coils may be above, below, or on the same plane as the primary inductor 5. In one embodiment, each of eddy current coils may correspond to a loop of the primary inductor 5.

In operation, a first time-varying current is coupled to the primary inductor 5 and induces a first magnetic field that in turn induces a time-varying voltage in the eddy current coil 3. For example, the first time-varying current in inductor 5 may flow in the clockwise direction. The current induces a magnetic field in a direction normal to the major plane of primary inductor 5. If the eddy current coil of the secondary inductor 3 is opened or in series with a high resistance, no eddy current flows through the eddy current coil and the inductance of the primary inductor 5 remains unchanged. However, if the eddy current coil is not opened, e.g., is floating or a closed-loop, an eddy current flows through the eddy current coil. The eddy current, which flows in the opposite direction of the first time-varying current, induces a second magnetic field. The second magnetic field, which opposes the first magnetic field, reduces the inductance of the primary inductor 5.

The variable resistor(s) 7 provided in series with the eddy current coil of the secondary inductor 3 provide a means for controlling the eddy current in the secondary inductor 3. By varying the resistance of the variable resistors 7, the eddy current can be increased or decreased, which changes the inductance of the primary inductor 5. That is, if the resistance is increased, then the eddy current in the eddy current coil of secondary inductor 3 reduces, which reduces the strength of the secondary magnetic field opposing the first magnetic field. With increased resistance, the inductance of the primary inductor 5 approaches the standard inductance of the primary inductor. Of course, if the resistance is decreased, then the eddy current in the eddy current coil of the secondary inductor 3 increases, which increases the strength of the secondary magnetic field opposing the first magnetic field. This reduces the inductance of the primary inductor 5.

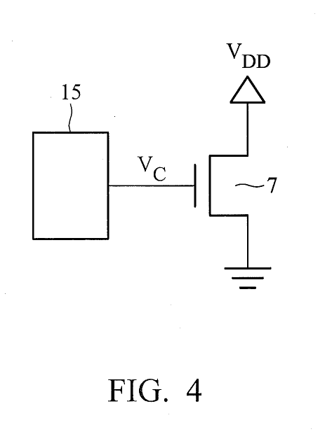

If the resistance of the variable resistor is itself continuously variable across a range of resistances, then the inductance of the primary inductor 5 can also be continuously tuned across a range of inductances. In one embodiment, variable resistors 7 may be a MOS transistor biased to act as a resistor. FIG. 4 illustrates a MOS transistor that can serve as a variable resistor 7. The MOS transistor should be biased for MOS operation in the linear or triode region, for example, Vc(Vgs)>Vth and Vds˜0V. The resistance of the MOS resistor can range, for example, from about 0.5 to 10K ohms. A controller 15, such as an auto voltage controller (AVC), which is controlled digitally or by other system parts depending on the inductance that is needed, provides a control voltage Vc for biasing the gate of the MOS device to control the resistance of the variable resistor 7.

In an alternative embodiment, the variable resistor can be any kind of switch resistor array, or the like. In this embodiment, the level of granularity of the tuning of the inductance of the primary inductor 5 is limited only by the discrete resistance changes available from the switch resistor array.

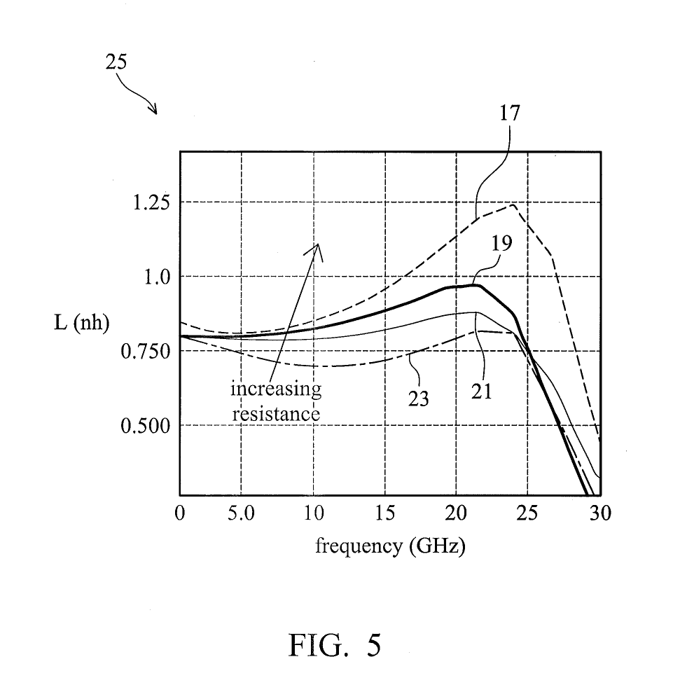

FIG. 5 is a graphical depiction from a simulation showing the relationship between the resistance applied to secondary inductor 3 and the inductance value of continuous tunable inductor 1 across a range of frequencies. The y-axis of graph 25 depicts the inductance (L), measured in nH, of tunable inductor 1. The x-axis of graph 25 depicts the frequency of the time-varying current in the primary inductor measured in GHz. Lines 17, 19, 21, and 23 are depictions of inductance values of the tunable inductor 1 at varying resistance levels measured in ohms (Ω). Line 17 refers to points on graph 25 when a total resistance of 100Ω is applied in series with the closed loop of secondary inductor 3. Line 19 refers to points on graph 25 when a total resistance of 105Ω is applied in series with the secondary inductor 3. Line 21 refers to points on graph 25 when a resistance of 5Ω is applied in series with the secondary inductor 3. Finally, line 23 refers to points on graph 25 when a resistance of 1Ω is applied in series with secondary inductor 3. In general, graph 25 confirms that as resistance increases in the eddy coil of the secondary inductor, the inductance of the primary inductor increases, and vice versa.

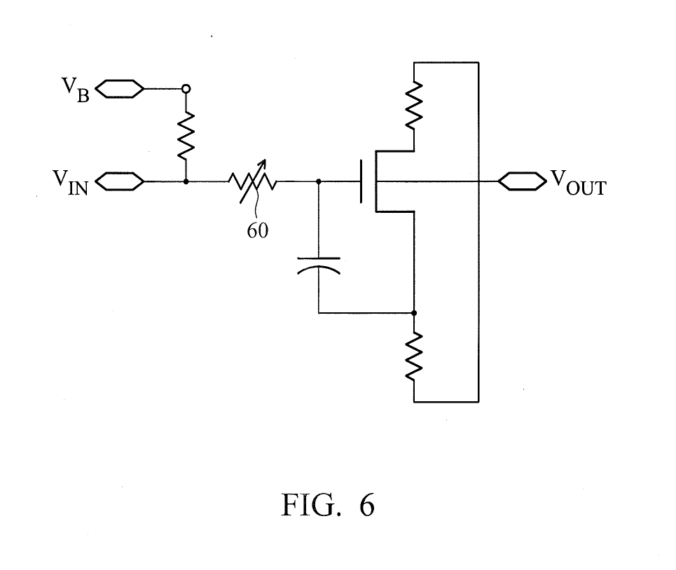

FIG. 6 is a schematic diagram illustrating a low noise amplifier that includes a tunable inductor 60, such as a tunable inductor described above in connection with FIGS. 1-4. Those of ordinary skill in this field will understand that only one example of the use of an integrated tunable inductor is shown in FIG. 6 and that the tunable inductor can be integrated with any number of IC devices. For instance, the tunable inductor can be used for enhancing the performance of circuits including wideband CS LNA with low noise figure, phase tuning circuits, high performance LC tanks for high frequency VCOs, impedance matching networks, and filter circuits

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

What is claimed is:

1. An integrated tunable inductor, comprising:
a primary inductor having a plurality of inductor turns;
at least one closed loop eddy current coil proximate said primary inductor; and
at least one variable resistor integrated in series with the eddy current coil.

2. The tunable inductor of claim 1, wherein the at least one variable resistor includes a MOS transistor device.

3. The tunable inductor of claim 1, wherein the at least one variable resistor includes a switch resistor array.

4. The tunable inductor of claim 1, wherein the primary inductor and the at least one eddy current coil reside on different metallization layers of an integrated circuit.

5. The tunable inductor of claim 1, further comprising at least one controller in connection with said at least one variable resistor for adjusting the resistance of the variable resistor.

6. The tunable inductor of claim 1, wherein the primary inductor is a spiral or helical coil inductor.

7. The tunable inductor of claim 1, wherein an inductance of the primary inductor is continuously tunable across a range of inductance values.

8. The tunable inductor of claim 1, wherein an inductance of the primary inductor is tunable across a range of inductance values in discrete increments.

9. The tunable inductor of claim 1, wherein the at least one closed loop eddy current coil comprises a set of selectable closed loop eddy current coils each integrated with a respective variable resistor.

10. A continuously tunable inductor integrated in an integrated circuit formed over a semiconductor substrate, comprising:
a primary inductor having a plurality of inductor turns, the primary inductor providing a first magnetic field in response to a time-varying current;
at least one closed loop eddy current coil in proximity to the primary inductor such that the first magnetic field induces an eddy current in the eddy current coil, the eddy current coil providing a second magnetic field opposing the first magnetic field, a strength of said second magnetic field being based on the eddy current; and
at least one variable resistor integrated in series with the eddy current coil for adjusting the eddy current, wherein a resistance of the variable resistor is continuously variable across a range of resistance values, wherein adjusting the resistance of the variable resistor adjusts an inductance of the primary inductor.

11. The continuously tunable inductor of claim 10, wherein the at least one closed loop eddy current coil comprises a set of selectable closed loop eddy current coils each integrated with a respective variable resistor.

12. The continuously tunable inductor of claim 10, wherein the primary inductor comprises a spiral or helical coil inductor.

13. The continuously tunable inductor of claim 10, wherein the variable resistor comprises an MOS transistor device responsive to a control voltage.

14. The continuously tunable inductor of claim 13, further comprising a controller for providing the control voltage.

15. The continuously tunable inductor of claim 10, wherein said at least one closed loop eddy current coil is disposed above or below the primary inductor.

16. The continuously tunable inductor of claim 10, wherein the closed loop eddy current coil and primary inductor are coplanar.

17. A method of tuning a tunable inductor integrated in an integrated circuit, the tunable inductor comprising a primary inductor having a plurality of inductor turns and at least one closed loop eddy current coil proximate said primary inductor, the method comprising the step of:
adjusting a resistance of the closed loop eddy current coil, wherein adjustments in the resistance of the eddy current coil adjust an inductance of the primary inductor.

18. The method of claim 17, further comprising the step of providing a time-varying current to the primary inductor in response to which the primary inductor provides a first magnetic field that induces an eddy current in the closed loop eddy current coil, wherein the eddy current is adjusted in response to the resistance adjustment, the closed loop eddy current coil providing a second magnetic field in opposition to the first magnetic field, a strength of the second magnetic field being based on the eddy current.

19. The method of claim 17, wherein the resistance of the closed loop eddy current coil is continuously adjustable across a range of resistances, wherein the inductance of the primary inductance is continuously tunable across a range of inductances.

20. The method of claim 19, wherein the adjusting step comprises providing a control voltage to a MOS transistor integrated in series with the closed loop eddy current coil.
